(19) United States
(12) Patent Application Publication
(10) Pub. No.: US 2008/0258975 A1
(43) Pub. Date: Oct. 23, 2008

(54) Device and Method for Transmitting/Receiving Electromagnetic Hf Signals

(76) Inventors: Ewald Schmidt, Ludwigsburg (DE); Jurgen Hasch, Stuttgart (DE); Michael Mahler, Leinfelden-Echterdingen (DE)

Correspondence Address: KENYON & KENYON LLP, ONE BROADWAY, NEW YORK, NY, 10004, US

(21) Appl. No.: 11/631,225

(22) PCT Filed: May 24, 2005
(86) PCT No.: PCT/EP05/52359

§ 371 Date: Mar. 18, 2008

(30) Foreign Application Priority Data
Jul. 2, 2004 (DE) 10 2004 032 175.2

(51) Int. Cl. H01Q 9/04

(52) U.S. Cl. 343/700 MS

(57) ABSTRACT

A device for transmitting/receiving electromagnetic HF signals includes the following components: a first, essentially triangular, electrically conductive antenna section for transmitting and/or receiving HF signals; at least one second, third and fourth antenna section which correspond essentially to the first antenna section and form a polygon, in each case a triangular point being provided approximately in the region of the midpoint of the polygon, in whose center an antenna axis is situated; and a carrier device essentially perpendicular to the antenna axis; in each case, the triangular points of the triangular antenna sections, which, starting from the midpoint, form a funnel shape on the side facing away from the carrier device, are connected to HF signal connections of the carrier device in the region of the polygon midpoint; and in each case, two diametrically opposite antenna sections form an antenna element.

### FIELD OF THE INVENTION

The present invention relates to a device and a method for transmitting/receiving electromagnetic HF signals, and relates in particular to a HF antenna for a radar device which is operated in a frequency range between 1 and 5 GHz.

### BACKGROUND INFORMATION

Antennas for devices which are tuned for detecting objects such as lines in walls are generally optimized for the transmission and/or reception of high-frequency (HF) radar signals. A known antenna having a planar design is described in published German patent document DE 101 04 863.

This known planar antenna is able to be fixed in position with high mechanical stability on a printed circuit board, and generates a relatively symmetrical directional diagram having substantially reduced secondary lobes or side lobes. The known antenna is made of an electroconductive plate which, on opposite edges, has two bent side sections used as line arms for coupling the antenna to a feed network. Each of the two line arms is provided with its own connection terminal, which is connectable to the feed network located on a printed circuit board. The known antenna system has the disadvantage of a quite bulky type of construction, as well as a parasitic emission between the bent side sections and the electroconductive plate. Moreover, only one beam direction is possible using the known radar antenna.

### SUMMARY

In contrast to the known design approach, the device of the present invention for transmitting/receiving electromagnetic HF signals, as well as the method for transmitting/receiving electromagnetic HF signals, have the advantage that measurement data can be obtained by the antenna in two directions orthogonal relative to each other, to permit better detection of objects to be measured. In addition, in spite of the dual emission/reception permitted, a smaller type of construction is made possible than in the related art. Parasitic emissions according to the related art cited, i.e., the emission of unwanted electromagnetic fields, are prevented by the configuration of the present invention using a screening. Apart from this, simple mounting is ensured, the arrangement being very stable mechanically.

The principle underlying the present invention is that essentially triangular, electrically conductive antenna sections which fan out in a funnel shape are situated diametrically opposite each other, which means in response to suitable excitation of these antenna sections, electromagnetic fields are formed which become detached and thus form an antenna. The geometry of the system according to the present invention is such that a detaching field forms both in cross-section and in longitudinal section in the space above the antenna without breaks or secondary lobes. At the same time, adjacent antenna sections are largely decoupled.

In accordance with the present invention, a device is made available for transmitting/receiving electromagnetic HF signals, which device includes: a first, essentially triangular, electrically conductive antenna section for transmitting and/or receiving HF signals; at least one second, third and fourth antenna section which basically correspond to the first antenna section and form a polygon, in each case a triangular point being provided approximately in the region of the midpoint of the polygon, in whose center an antenna axis is situated; and a carrier device essentially perpendicular to the antenna axis; in each case the triangular points of the triangular antenna sections, which start out from the midpoint, form a funnel shape at least in sections on the side facing away from the carrier device, are connected to HF signal connections of the carrier device in the region of the polygon midpoint, and in each case two diametrically opposite antenna sections form an antenna element.

According to one example refinement, in each case the triangular points of the essentially triangular antenna sections, which may taper into a rectangular segment, exhibit a predetermined curvature in the direction of the carrier device, in particular a multilayered printed circuit board, and lead into it in essentially perpendicular fashion at the HF signal connections electrically insulated from each other. These features serve to further improve the radiation characteristic of the antenna device according to the present invention.

According to a further example implementation, the surface of each of the at least four, essentially triangular antenna sections is flat or convex or concave and/or wavy or stepped at least in sections; a transition region, which runs perpendicular to the antenna axis at least in sections, is provided between the funnel shape and the electroconductive screening walls, each of which runs essentially parallel to the antenna axis, and into which each of the four basically triangular sections changes on a side opposite the triangular point. This holds the advantage of reducing parasitic emissions or the reception of parasitic signals, thereby further increasing the antenna characteristic.

According to a further example refinement, in each case two exposed edges of the at least four essentially triangular antenna sections are provided with angular and or round cutouts for the adaptation of antenna characteristics. The advantage here is the possibility for individual tuning to optimize the transmission/reception properties.

According to a further example embodiment, exactly four essentially triangular antenna sections form a square or a rectangle as polygon, the HF signal connections of the two adjacent, in each case diametrically opposite antenna sections being able to receive two HF-signal bands, e.g., of different, possibly partially overlapping frequency ranges. The radiation and reception frequencies may thereby be tuned to the form of the antenna device and vice versa, it being possible to easily differentiate the signals based on different frequency spectra.

According to a further example implementation, exactly four essentially triangular antenna sections form a square or a rectangle as polygon, the HF signal connections of the two adjacent, in each case diametrically opposite antenna sections being able to receive a HF signal in alternation. This advantageous development permits operation using two different polarization planes that are preferably displaced approximately 90° relative to each other, a HF source differentially triggering the two HF-signal connection pairs via a changeover switch.

According to another example refinement, the screening walls are contacted to an electroconductive screening device of the carrier device, which may be provided on or in the carrier device, and possibly both are connected, especially over a large surface, to a reference potential. This advantageous measure offers a radiation/reception characteristic that is improved again because of improved screening.

According to a further example refinement, approximately parallel to the carrier device, a radome is provided as covering over the at least four, essentially triangular antenna sections, the antenna device being movably supported via axles provided with wheels. Protection of the transmitting/receiving device is thus ensured, and the device is preferably movable via wheels rigidly connected by axles.

According to another example implementation, the at least four, essentially triangular antenna sections are made of separate sheets that are mechanically and/or electrically connected to each other in the region of the screening walls, or are made of a one-piece metal die-cast part or a plastic die-cast part which is provided, at least in sections, with a conductive metallization. Cost-effective manufacturing variants are thus advantageously made available.

According to another example implementation, the triangular points of the at least four, essentially triangular antenna sections are electrically connected to the HF-signal connections of the carrier device via solder contactings or conductive adhesive contactings. This likewise results in a cost-effective and simple assembly.

### BRIEF DESCRIPTION OF THE DRAWINGS

FIG. 1 shows a schematic, inclined top view of a transmitting/receiving device for clarifying a first example embodiment of the present invention.

FIG. 2 shows a schematic, cross-sectional view of a transmitting/receiving device for clarifying an example embodiment of the present invention.

FIG. 3 shows a schematic, cross-sectional view of a simplified transmitting/receiving device for clarifying the functioning method of the present invention.

FIGS. 4 and 5 show a schematic, inclined top view and bottom view, respectively, of a transmitting/receiving device for clarifying a further example embodiment of the present invention.

FIG. 6 shows a schematic top view of an antenna section for clarifying an example embodiment of the present invention.

FIG. 7 shows a schematic, inclined top view of the device according to FIG. 6 in the curved state.

FIG. 8 shows a schematic, inclined top view of a transmitting/receiving device for clarifying a further example embodiment of the present invention.

FIGS. 9 and 10 show a schematic, inclined top view and bottom view, respectively, of a transmitting/receiving device for clarifying a further example embodiment of the present invention.

FIG. 11 shows a schematic, inclined top view of a transmitting/receiving device for clarifying a further example embodiment of the present invention.

### DETAILED DESCRIPTION

In the figures, identical reference numerals denote the same or functionally equivalent component parts.

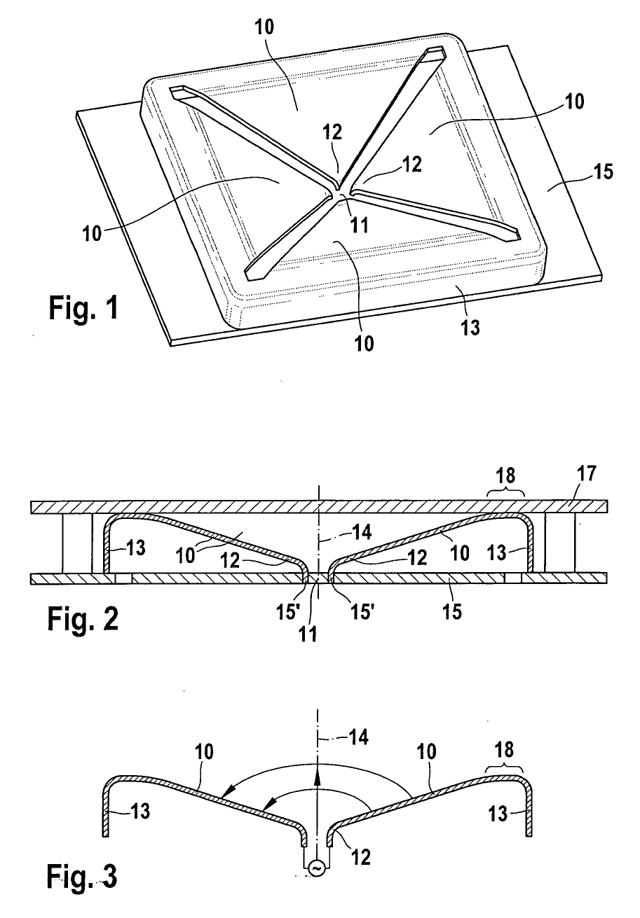

FIG. 1 shows a basic form of an antenna on a carrier device 15, e.g., a printed circuit board, without a cover. Four substantially identical, electrically conductive, essentially triangular antenna sections 10 are disposed in such a way that, in top view, they form a square with triangular points 12 in the region of midpoint 11 of the square. At the outer sides of the square, essentially triangular antenna sections 10 change into electrically conductive screening walls 13 running basically perpendicular to carrier device 15. According to FIG. 1, an example embodiment is shown in which the four antenna sections 10 and respective screening walls 13 are produced in one piece, e.g., of die-cast aluminum. Triangular points 12 situated in the region of midpoint 11 of the arrangement are shifted downward in the direction of carrier device 15 in relation to the top edges of screening walls 13, so that a funnel shape or cone shape results. Triangular points 12 are connected to HF-signal connections (not shown in FIG. 1) of carrier device 15.

FIG. 2 shows a cross-section of a configuration comparable to FIG. 1, however with a cover device 17 in the form of a radome made of an electrically non-conductive material. Cover device 17 runs essentially parallel to carrier device 15. Between essentially triangular antenna sections 10 and screening walls 13, a transition section 18 is provided which runs basically parallel to carrier device 15 and, in particular, touches cover device 17.

If mechanical loads get onto cover device 17, i.e., especially a radome which contacts the transmitting/receiving device at its upper side, the load is transferred over a large surface via screening wall 13 at the entire periphery, to carrier device 15. HF-signal connections 15′ situated inside, which, in top view, are electrically connected to triangular points 12 of essentially triangular antenna sections 10, are insulated from each other. Essentially triangular antenna sections 10 may change in triangular points 12 into rectangular segments (cannot be seen in FIGS. 1 and 2) which exhibit a predetermined radius of curvature. The radius of curvature between antenna sections 10, running at an angle in the cross-section according to FIG. 2, and triangular points 12 leading into the region of the carrier device perpendicular to carrier device 15, is formed in such a way that radar waves are able to detach easily.

The sectional view in FIG. 2 shows clearly the funnel shape between two diametrically opposite antenna sections 10, an antenna axis 14 running in the region of midpoint 11. Carrier device 15 may be a multi-layer printed circuit board which has a traversing screening plane (not shown in FIG. 2), the screening plane being electroconductively joined to screening walls 13.

The configuration according to FIG. 3 shows only one antenna element made up of essentially triangular antenna sections 10, as well as screening walls 13 together with transition section 18. The curved arrows depict an electromagnetic alternating field which is fed by differential HF signals, i.e., with HF signals displaced essentially by 1800 relative to each other. The electromagnetic waves propagate along antenna axis 14, e.g., in the radar range having a frequency between 2 and 5 GHz. In this context, the antenna is made up of a cuboidal housing having four HF-signal connections 15′ according to FIGS. 1 and 2 situated inside.

According to FIG. 3, in each case two diametrically opposite HF-signal connections 15′ are excited differentially by HF signals out of phase by approximately 180° relative to each other. The result is that the device operates with two different polarization planes, e.g., displaced by approximately 90° relative to each other. The opposite connections are situated geometrically close together, and may have a parallel direction relative to antenna axis 14, however at least one acute angle. After a short, e.g., rectangular segment, triangular point 12 changes into an essentially triangular antenna section 10. The triangular point has a rounded curvature which changes into a planar antenna section 10. However, an at least sectionally wavy and/or stepped and/or concave and/or convex cross-sectional shape of antenna sections 10 is also conceivable.

An upper section of antenna section 10 changes into a tangential line when radii coincide in absolute amount at the same midpoint between inclined antenna section 10 and perpendicular screening wall 13. At its lower end in the region of carrier device 15, screening wall 13 is connected in planar fashion or at least partially to a system ground, preferably to a reference potential, just like a flat screening made of electroconductive material and integrated into carrier device 15. Consequently, electromagnetic fields which form below antenna sections 10 are shielded outwardly.

Thus, between diametrically opposite antenna sections 10 running in the shape of a cone or funnel, electromagnetic fields form which detach. The geometry is such that a detaching field forms in cross-section and in longitudinal section above the transmitting/receiving device without breaks. In this context, the directly adjacent antenna sections are substantially decoupled.

According to the example embodiment in FIG. 1, observing the configuration according to FIG. 1 in top view, the transmitting/receiving device has four planes of symmetry, one horizontal, one vertical, as well as the planes situated at an angle of 45° thereto. According to a further embodiment, it is possible to dimension two antenna elements, perpendicular relative to each other and formed by diametrically opposite antenna sections 10, differently, so that instead of a square according to FIG. 1, in top view a rectangle (not shown) is formed. In that case, antenna sections 10 along the long side are preferably operated with a lower frequency of, e.g., 2 to 3 GHz, and along the cross side, i.e., in the orthogonal direction thereto, with a frequency of, e.g., 2.5 to 4 GHz. This results in only two planes of symmetry.

For plastic holders (not shown) below antenna sections 10, partial cutouts may be introduced into screening walls 13, on condition they are not too large and are positioned in such a way that no maxima are produced in the screened space between carrier device 15 and antenna sections 10 as well as screening walls 13, for such cutouts have no negative influence on the electromagnetic waves detaching above to the outside.

Advantageously, the four HF-signal connections 15′ project into plated-through holes, suitably insulated from each other, in carrier device 15 or printed circuit board, and are electrically connected there to triangular points 12. A metal layer provided in/out of carrier device 15 and facing away from the funnel shape is contacted substantially over the entire surface to a system ground or a reference potential, as well as the bottom side of screening walls 13. Also possible, however, is a contact in each case between one middle conductor of a coaxial cable and one triangular point 12 of one antenna section 10, whose outer conductor is connected to the system ground or a reference potential. Combinations of the possibilities just indicated are also conceivable.

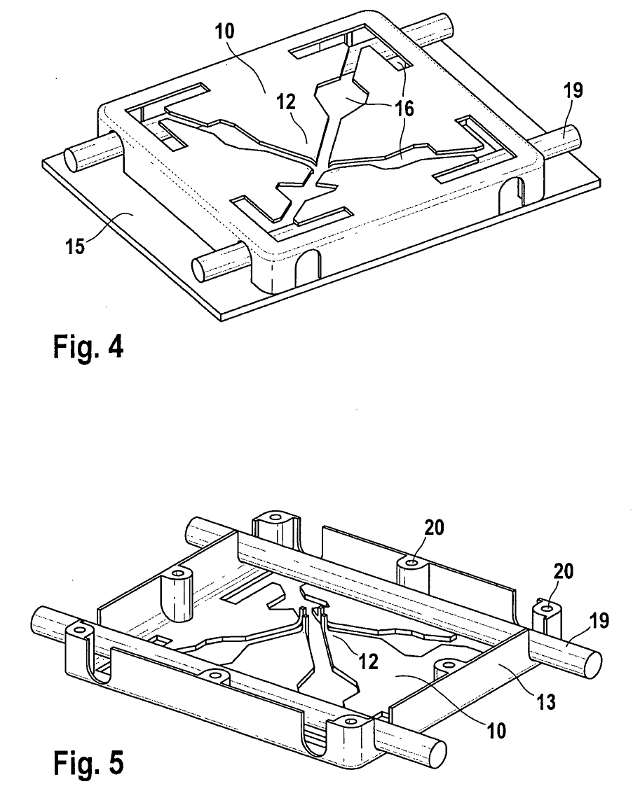

Predefined boundary conditions, such as a lower and upper limit frequency, a maximum horizontal and/or vertical installation geometry of the transmitting/receiving device may be taken into consideration and adjusted within certain limits. In principle, the total length and upper width of essentially triangular antenna sections 10 determine the transmission/reception range possible. Antenna characteristics may be modified and, in particular, the radiation pattern may be adjusted by cutouts 16 according to FIG. 4 in essentially triangular antenna sections 10. In addition, it is possible to reduce the dimension necessary for a lower setpoint frequency by suitable cutouts 16. The lower limit frequency may be reduced and partial improvements in the antenna matching may be attained by cutouts 16 according to FIG. 4 and FIG. 5 (in the bottom view) which are located at the two exposed edges of antenna section 10 in the upper and middle region. At the same time, other formations of the cutouts, such as round, saw-tooth-shaped, or wavy are also possible, by which similar effects are attainable, given a suitable design.

The antenna devices shown in the example embodiments according to FIGS. 4 and 5 may be produced from die-cast aluminum, and feature protuberances 20 having mounting holes by which the transmitting/receiving device is mechanically and/or electrically joined to carrier device 15. Axles 19 are used for the rigid joining of wheels situated outside (not shown), with whose aid the transmitting/receiving device is able to be moved in parallel over surfaces. To save on space, these axles 19 run within the outside dimensions of the transmitting/receiving device with its antenna sections 10, and are made of a non-conductive material. The openings for leading axles 19 through are situated at predetermined, calculated positions at which no field maximum of the electromagnetic waves occurs in the space formed by antenna sections 10.

The feeding or deriving or distributing of HF-signals necessary for operating the transmitting/receiving device advantageously takes place on or within carrier device 15, e.g., a multi-layer printed circuit board. When leads run on the screening layer (not shown) facing the antenna side, the leads being electrically insulated from the screening layer, they are implemented using grounded coplanar technology. In addition to an example embodiment as a die-cast part made of metal, e.g., die-cast aluminum, it is possible to provide a comparable injection-molded part made of plastic, which is covered with a conductive metallic layer.

By openings that are suitable for injection molding and are distributed in the plastic member, a quasi homogeneous, sectionally conductive antenna element is formed having comparable properties.

According to the example embodiments described, mounting proves to be very simple, since the transmitting/receiving antenna is bolted to carrier device 15 or a conductor or ground-potential plate via mounting holes 20 according to FIGS. 4 and 5 which are cast or die-cast during these processes. The four HF connection contacts 15′ are either soldered or bonded to triangular points 12 using conductive adhesive. In addition, when using a basic square form, the antennas may be mounted in any direction.

Diametrically opposite antenna sections 10, which are controllable independently of one another by HF-signal connections 15′, are thus able to transmit/receive two polarizations situated orthogonally relative to each other.

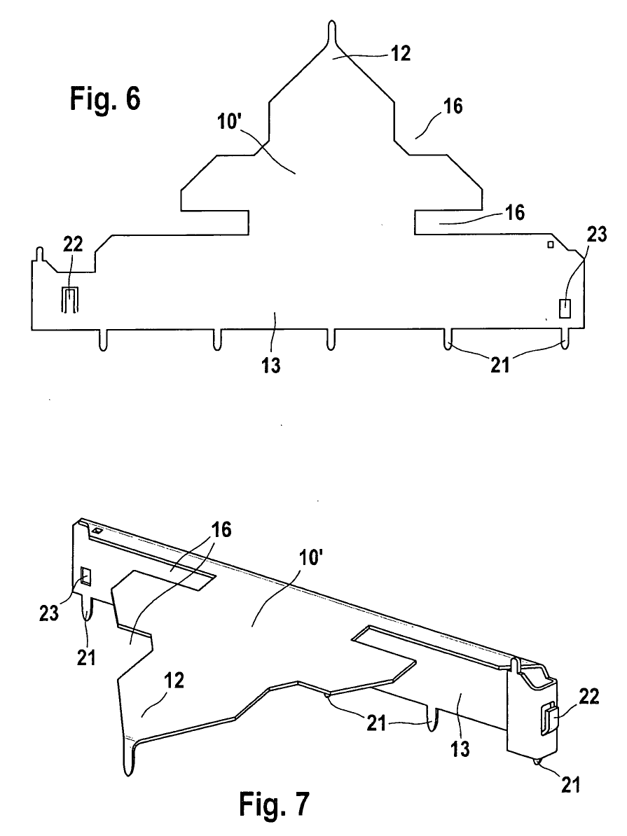

FIG. 6 shows an essentially triangular antenna section 10 as a single sheet 10′. Single sheet 10′ is a stamped part made of a metal such as tin plate, and, in addition to triangular point 12 and screening wall 13, has cutouts 16, a catching and/or suspension element 22, as well as a catching and/or suspension opening 23. Single sheet 10′ may be connected mechanically and/or electrically to a carrier device 15 via mechanical and/or electrical connecting elements 21. FIG. 7 shows single sheet 10′ according to FIG. 6 after being processed by deforming. Screening wall 13 has an angle of less than 90° with respect to essentially triangular antenna section 10, and triangular point 12 exhibits a predetermined curvature. Screening wall 13 is bent over in the region of catching and/or suspension element 22.

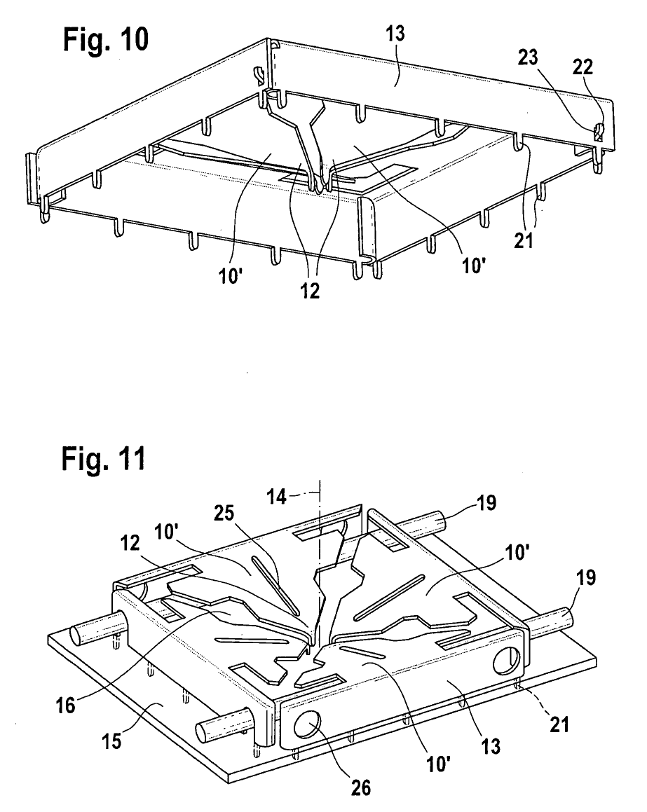

In the inclined top view according to FIG. 9, four antenna elements according to FIG. 7 are mounted on a carrier device 15 in a configuration comparable to FIG. 1. In this case, individual sheets 10′ together with catching and/or suspension elements 22 as well as catching and/or suspension openings 23 are formed in such a way that they are joined by insertion into one another, and then form one antenna unit. For example, this unit may then be soldered onto a mounting board 15, preferably a printed circuit board. If necessary, single sheets 10′ may be soldered or bonded at the edges and at catching and/or suspension elements and openings 22, 23 either prior to or after mounting on carrier device 15. In this manner, given a certain preassembly effort, a sturdy transmitting/receiving device is provided comparable to that described with reference to FIG. 1. FIG. 10 shows the arrangement according to FIG. 9 in a bottom view without the carrier device.

There is also the possibility of mounting single sheets 10′ individually on the carrier device, the single sheets first having an electrical and/or mechanical connection after being mounted on carrier device 15. When all four sheets 10′ are mounted, the antenna is complete; if needed, sheets 10′ may likewise be soldered at the common edges. The example embodiment according to FIG. 11 describes a configuration in which single sheets 10′ do not directly touch each other, even after being mounted on carrier device 15. Each single sheet 10′ is soldered by itself into the carrier device. Only with the installation of all four single sheets 10′ is the transmitting/receiving device formed. To reduce the effects of eddy currents in essentially triangular antenna sections 10, according to FIG. 11, slits or cutouts 25 are provided. These slits or cutouts for reducing the influence of eddy currents may likewise be used for all other example embodiments of the present invention, and may be provided along the mirror axis of antenna sections 10. In FIG. 11, cutouts are also shown in screening walls 13, two wheel axles 19 according to FIGS. 4 and 5 being introduced in the transverse direction.

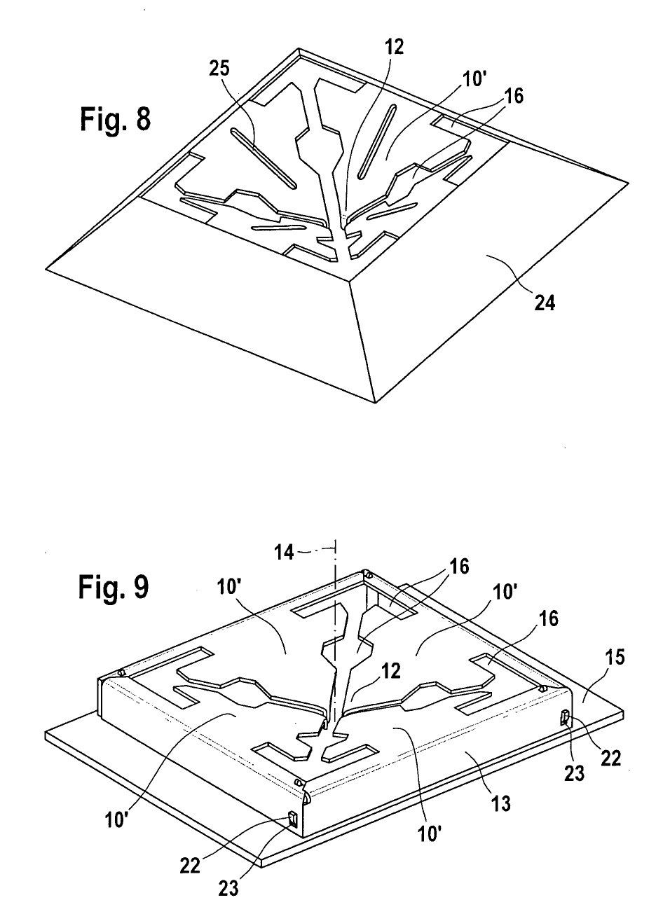

According to FIG. 8, four single sheets 10′ according to FIG. 7, i.e., already bent, are clipped into a suitable plastic holder or are co-injected directly as insertion parts. In this case, single sheets 10′ do not mutually contact; plastic holder 24 and single sheets 10′ are primarily supported at screening walls 13 (not shown in FIG. 8). The sheets also do not touch each other after the installation on a carrier device 15 (not shown). Plastic holder 24 is especially advantageous when it is used simultaneously as a function carrier or holder for further elements, such as low-frequency coil braces, around the transmitting/receiving device. The costs are very low for all the variants made of single sheets. If the piece numbers are low, the sheet-metal parts may be cut out by laser. Only minimal tool costs are incurred for the simple bending devices likewise needed. If large piece numbers are provided, completely automatic production of single sheets 10′ is possible using a synchronized system. However, the cast parts and/or injection-molded parts according to FIG. 1 to 5 require more complex tools.

Although the present invention has been described above with reference to exemplary embodiments, it is not limited thereto, but rather is modifiable in many ways. Thus, for example, in the region between screening wall 13 and triangular point 12, i.e., on essentially triangular antenna sections 10, beads may be provided to reduce mechanical vibrations.

Besides the exemplary embodiments described, each having four essentially triangular antenna sections, higher even numbers of essentially triangular antenna sections, which then form a polygon, are also feasible, it being possible to apply an HF signal as described to diametrically opposite antenna sections. Moreover, the ratios of sizes and the materials are only to be considered by way of example.

1-11. (canceled)

12. A device for at least one of transmitting and receiving high frequency electromagnetic signals, comprising:
at least four electrically conductive antenna sections for at least one of transmitting and receiving high frequency signals, wherein each one of the four electrically conductive antenna sections is substantially triangular, and wherein the four electrically conductive antenna sections form a polygon, and wherein each electrically conductive antenna section has a triangular tip positioned approximately in a center of the polygon, and wherein the center of the polygon corresponds to an antenna axis; and
a carrier device extending essentially perpendicular to the antenna axis;
wherein the triangular tip of each electrically conductive antenna section is connected to a corresponding high frequency signal connector of the carrier device in a region of the center of the polygon, and wherein two diametrically opposite electrically conductive antenna sections form an antenna element, and wherein the four electrically conductive antenna sections form a funnel shape on the side facing away from the carrier device, a center axis of the funnel shape substantially coinciding with the antenna axis.

13. The device as recited in claim 12, wherein each triangular tip exhibits a predetermined curvature in the direction of the carrier device and is connected to the carrier device substantially perpendicularly at the corresponding high frequency signal connector, and wherein the high frequency signal connectors are electrically insulated from each other.

14. The device as recited in claim 13, further comprising:
four electro-conductive screening walls corresponding to the four electrically conductive antenna section, wherein each electro-conductive screening wall extends substantially parallel to the antenna axis;
wherein at least a portion of a surface of each of the four electrically conductive antenna sections is one of flat, convex, concave, wavy, and stepped, and wherein a transition region extending substantially perpendicularly to the antenna axis is provided between each of the four electro-conductive screening walls and a corresponding broad edge of each electrically conductive antenna section opposite of the triangular tip and forming an upper edge segment of the funnel shape.

15. The device as recited in claim 14, wherein for each electrically conductive antenna section, two side edges leading to the triangular tip are each provided with at least one cut-out of a predetermined shape for adaptation of antenna characteristics.

16. The device as recited in claim 14, wherein exactly four electrically conductive antenna sections form one of a square and a rectangle, and wherein the high frequency signal connectors of two diametrically opposite electrically conductive antenna sections are configured to receive two high frequency signal bands that are at least partially different.

17. The device as recited in claim 14, wherein exactly four electrically conductive antenna sections form one of a square and a rectangle, and wherein the high frequency signal connectors of two diametrically opposite electrically conductive antenna sections are configured to receive a high frequency signal in alternation.

18. The device as recited in claim 14, wherein each electro-conductive screening wall is connected to an electro-conductive screening device of the carrier device, and wherein both the electro-conductive screening wall and the electro-conductive screening device are connected to a reference potential.

19. The device as recited in claim 14, further comprising:
a radome provided as a cover over the at least four electrically conductive antenna sections, wherein the radome extends approximately parallel to the carrier device; and
at least one axle with wheels for movably supporting the device.

20. The device as recited in claim 14, wherein the at least four electrically conductive antenna sections are made of one of: a) separate sheets that are at least one of mechanically and electrically connected to each other in the region of the four electro-conductive screening walls; and b) a one-piece die-cast part which is provided, at least in sections, with a conductive metallization.

21. The device as recited in claim 14, wherein the triangular tips of the at least four electrically conductive antenna sections are electrically connected to the high frequency signal connectors on the carrier device via one of solder connections and conductive adhesive connections.

22. A method for at least one of transmitting and receiving high frequency electromagnetic signals, comprising:
providing at least four electrically conductive antenna sections for at least one of transmitting and receiving high frequency signals, wherein each one of the four electrically conductive antenna sections is substantially triangular, and wherein the four electrically conductive antenna sections form a polygon, and wherein each electrically conductive antenna section has a triangular tip positioned approximately in a center of the polygon, and wherein the center of the polygon corresponds to an antenna axis;
providing a carrier device extending essentially perpendicular to the antenna axis, wherein the triangular tip of each electrically conductive antenna section is connected to a corresponding high frequency signal connector of the carrier device in a region of the center of the polygon; and
applying to each of two diametrically opposite high frequency signal connectors a differential high frequency signal of a predetermined frequency range, the differential high frequency signals for the two diametrically opposite high frequency signal connectors being out of phase by approximately 180° relative to each other, wherein the at least four electrically conductive antenna sections form a funnel shape on the side facing away from the carrier device, a center axis of the funnel shape substantially coinciding with the antenna axis.
